(19) United States
(12) Patent Application Publication
(10) Pub. No.: US 2002/0105684 A1
(43) Pub. Date: Aug. 8, 2002

(54) Contractible outer-shell apparatus of a scanning device

(76) Inventor: Chih-Wen Huang, Hsinchu (TW)

Correspondence Address: Raymond Sun, 12420 Woodhall Way, Tustin, CA, 92782, US

(21) Appl. No.: 09/769,225

(22) Filed: Jan. 24, 2001

(51) Int. Cl. H04N 1/04

(52) U.S. Cl. 358/474

(57) ABSTRACT

The contractible outer-shell apparatus of a scanning device comprises a first shell body and a second shell body. There is a first space in the interior of the first shell body, of which four side-surface constitute one trough opening, and of which one side is provided with a manuscript weight-bearing glass. There is a second space in the interior of the second shell body. The second shell body is incased into the trough opening of the first body, by a way of relative motion which will connect the interior spaces of both the first shell body and the second shell body to a containing space of one body. The second shell body can move upward and downward along the direction confined by the trough opening of the first shell body between a contraction position and a stretch position. In an idle state, the second shell body can be adjusted to a contraction position to reduce the total volume of the device to make it be put away, placed, conveyed easily and to reduce cost.

### FIELD OF THE INVENTION

The present invention relates to the contractible outer-shell apparatus of a scanning device, particularly to the scanning device of an adjustable altitude of outer shell. In an idle state, with smaller volume, it will make the scanning device be conveyed, put away and placed easily.

### BACKGROUND OF THE INVENTION

According to the prior art of a scanning device, most of which the upper shell and the lower shell are fixed, and of which the total volume can not be adjustable, therefore, even in an idle state, and which occupies a great accumulative materials during conveyance and increases unnecessary cost. In the market of scanner, of which the price is coming down daily, nowadays, the daily reduction of its gross earning is very unprofitable. To improve the defects of the prior scanning device and reduce the volume of a scanning device, without influencing its normal operation, the characteristic of this invention is to provide two movable upper and lower shell bodies in lieu of the prior fixed and immovable outer-shell. Through the movable upper and lower shell bodies, it is possible to adjust its containing space to make the scanning device operate in the period of normal application. While in the idle state, the adjustment of the upper and lower shell bodies of the scanning device, which is contracted to a minimum volume, will make the scanning device easy to be put away, placed and conveyed. Further, this function will reach the object of saving cost and improve the defects of the prior apparatus.

### SUMMARY OF THE INVENTION

The major object of this invention is to provide the contractible outer-shell apparatus of a scanning device. By adjusting its upper and lower outer-shell, it is possible to change the volume of the scanning device. In an idle state, it can be put away and placed with a smaller volume.

Another object of this invention is to provide the contractible outer-shell apparatus of a scanning device, by reducing the volume of its interior light-path apparatus to reduce the volume of the scanning device.

To reach the above-mentioned objects, the contractible outer-shell apparatus of a scanning device, comprising: a first shell body, in which there is a first space in the interior, and of which four side-surface constitute one trough opening, and of which one side is provided with a penetration zone to arrange a manuscript weight-bearing glass; a second shell body, in which there is a second space in the interior, and which is incased into the trough opening of the first body, by a way of relative motion which will connect the interior spaces of both the first shell body and the second shell body to a containing space of one body, and which can move upward and downward in the direction confined by the trough opening of the first shell body between a contraction position and a stretch position to change the volume of the device.

To describe the operation principle of the contractible outer-shell apparatus of a scanning device provided by this invention in a more clear way, a detailed description in tune with several figures are as following:

### BRIEF DESCRIPTION OF THE DRAWINGS

FIG. 1 is the illustration of element of the first preferred embodiment of this invention.

FIG. 2A is the illustration of installation structure of the second preferred embodiment of this invention during operation period.

FIG. 2B is the illustration of installation structure of the second preferred embodiment of this invention during putting-away and placing period.

FIG. 3A is the illustration of installation structure of the third preferred embodiment of this invention during putting-away and placing period.

FIG. 3B is the illustration of installation structure of the third preferred embodiment of this invention during operation period.

FIG. 4 is the illustration of the fourth preferred embodiment of this invention.

FIG. 5 is the illustration of the embodiment of the light-path apparatus of this invention.

FIG. 6A is the illustration of installation structure of the fifth preferred embodiment of this invention during operation period.

FIG. 6B is the illustration of installation structure of the fifth preferred embodiment of this invention during putting-away and placing period.

FIG. 7A is the illustration of installation structure of the sixth preferred embodiment of this invention during operation period.

FIG. 7B is the illustration of installation structure of the sixth preferred embodiment of this invention during putting-away and placing period.

FIG. 8A is the illustration of installation structure of the seventh preferred embodiment of this invention during operation period.

FIG. 8B is the illustration of installation structure of the seventh preferred embodiment of this invention during putting-away and placing period.

### DETAILED DESCRIPTION OF THE PREFERRED EMBODIMENTS

During an idle state, to make it possible for the scanning device to be put away and placed with a smaller volume will reduce the occupying space and cost during conveyance. Therefore, with the method of adjusting the upper and lower outer-shell and reducing the installation volume of the interior of the light-path apparatus, this invention can change the total volume of the scanning device.

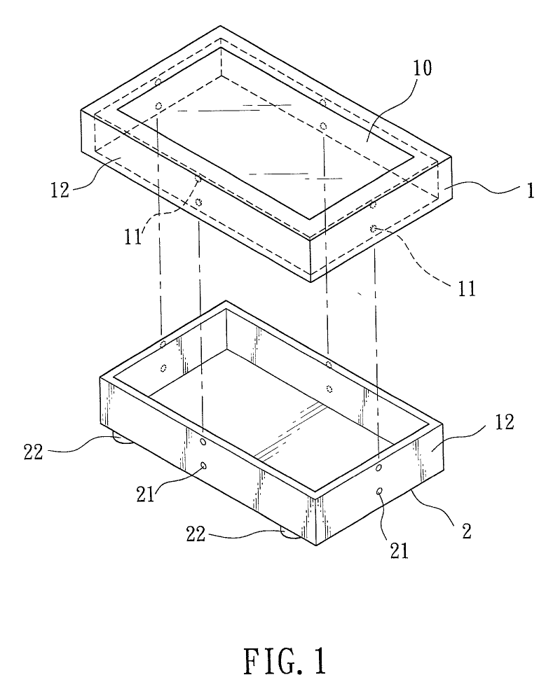

The members of the review committee please refer to the FIG. 1, which shows the illustration of the elements of the first preferred embodiment of this invention, and which comprises a first shell body 1 and a second shell body 2. There is a penetration zone for providing an installation of a manuscript weight-bearing glass 10 on the upper side surface of the first shell body 1. To make it convenient to support the device keeping stable during scanning, there are several legs 20 arranged on the lower side surface of the second shell body 2. There are several upper buttoning-together apparatus 11 and lower buttoning-together apparatus 21 arranged correspondingly on the four side-surface 12 of the first shell body 1 and the second shell body 2. Near the lower edge of the four side-surface of the first body 1, on which there are four upper buttoning-together apparatus 11. Near the upper edge and lower edge of the four side-surface of the second body 2, on which there are four lower buttoning-together apparatus 21, respectively. During the state of operation, the four upper buttoning-together apparatus 11 of the first shell 1 may button together with the four lower buttoning-together apparatus 21 of the upper edges of the second shell body. In the meantime, there will be a larger containing space in the interior to make the light-path apparatus 6 process the normal scanning operation. During the non-operation period, the four upper buttoning-together apparatus of the first shell body 1 are buttoned together with the four lower buttoning-together apparatus of the lower edges of the second shell body 2, to reduce the whole volume of the scanning device and make it be put away and placed easily.

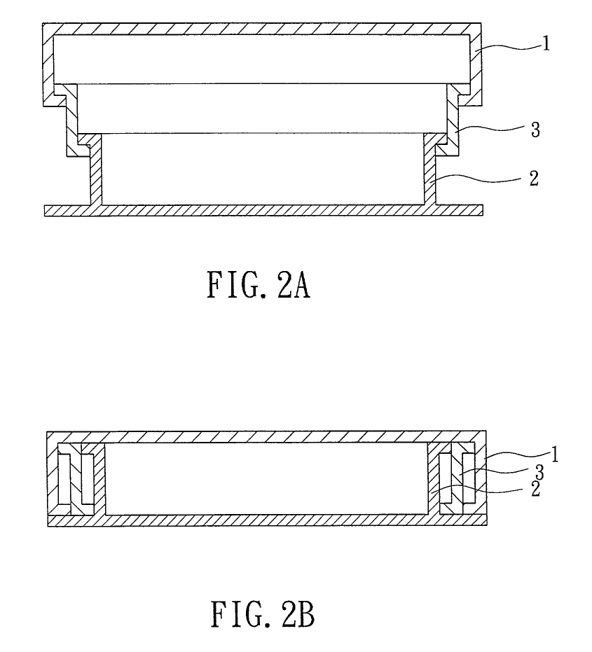

The members of the review committee please refer to the FIG. 2(A) and FIG. 2(B), which shows the illustration of the elements of the second preferred embodiment of this invention, and which comprises a middle lid 3 between the first shell body 1 and the second shell body 2. As shown in FIG. 2(A), during the state of operation, the lower edge of the first shell body 1 is connected with the upper edge of the middle lid 3, and the upper edge of the second shell body 2 is connected with lower edge of middle lid 3, such that three connected bodies form a larger containing space, in which the light-path apparatus may process the normal scanning operation. As shown in FIG. 2(B), during the idle state, three bodies can be incased together to form a minimum volume to reach the effect of less occupying space and convenient conveyance.

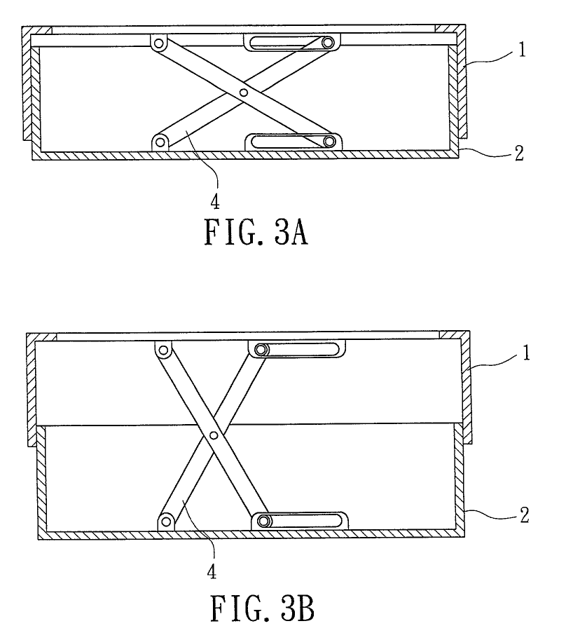

The members of the review committee please refer to the FIG. 3(A) and FIG. 3(B), which shows the illustration of the third preferred embodiment of this invention, and which comprises the first shell body 1 and the second shell body 2. On the four side-surface of the shell bodies, there are two sets of connection rods 4 on opposing sides. This embodiment, through the motions of the connection rods 4, will make the first shell body 1 far away or near to the second shell body 2. During the operation period, applying the connection rods 4 to adjust the shell body 1 to a higher altitude will make the first shell body 1 far away from the second shell body 2 and form a larger containing space in the interior. During the non-operation period, adjusting the connection rods 4 will make the first shell body 1 place directly on the top of the second shell body 2 to reach the minimum volume for convenient conveyance, putting away and placing.

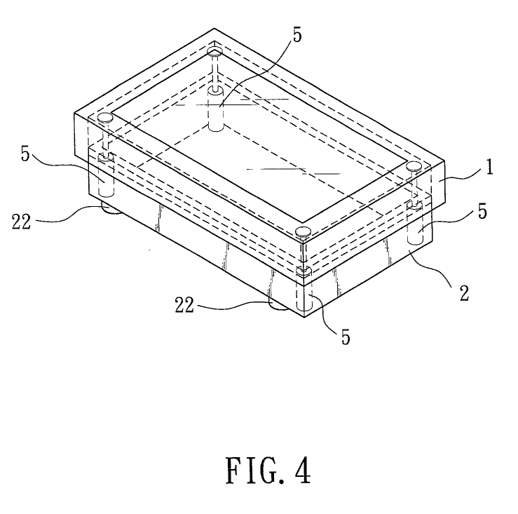

The members of the review committee please refer to the FIG. 4, which shows the illustration of the fourth preferred embodiment of this invention. Four solenoid valves 5 are arranged in the four corners of the shell body 2. Through the rising and falling of the four solenoid valves 5 to move the first shell body 1 far away or near to the second shell body 2, will generate the size change of the interior containing space. During operation state, to rise up the solenoid valves 5 will make a larger containing space for the scanning device interior. During non-operation state, to lower down the solenoid valves 5 will make the first shell body 1 move close to the second shell body 2 and reduce the whole volume for the convenience of conveyance, putting away and placing.

In other preferred embodiments of this invention, the light-path apparatus 6 is positioned on the first shell body 1, wherein the light source apparatus 7 is arranged inside the light-path apparatus 6 which can move back and forth along the guiding rod 23 to process scanning. In the following several preferred embodiments, the light-path is positioned on the second shell body 2 by the application of the supports 22. By the way of adjusting the first shell body 1 and the second shell body 2, will adjust the volume of the scanning device, and without influencing the function of scanning.

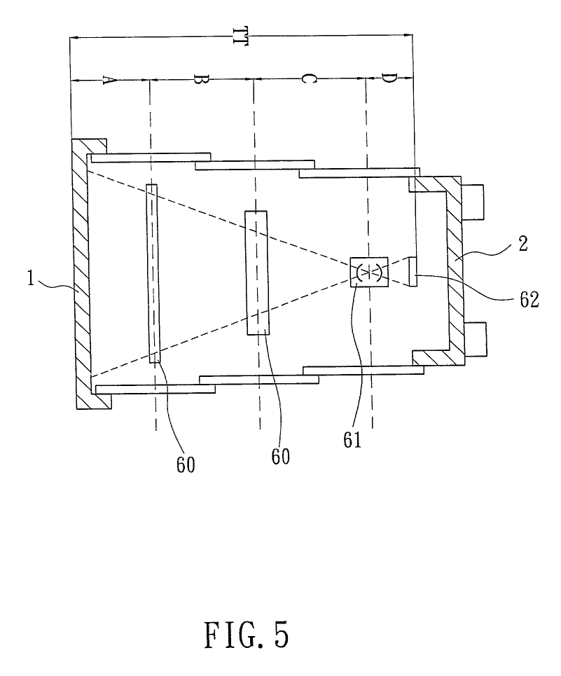

The members of the review committee please refer to the FIG. 5, which shows the illustration of an embodiment of this invention of the light-path apparatus 6 which comprises: a reflective mirror set 60, a lens 61, and a charge-coupling element 62. In this illustration, the reflective mirror set 60 is composed of two reflective mirrors which can receive and reflect the light transmitted by the light source by an appropriate arrangement of the respective position of two reflective mirrors. The lens 61 is applied to receive the light transmitted by the said reflective mirror set 60, and to concentrate the light on its focus. The charge-coupling element 62, arranged on the focus, can transfer the light into digital signals that can be processed by computer. In this figure, A, B, C, and D represent the distance of each light section. The total length summation of the four sections is the total length of light-path TT that must keep constant during the whole process of scanning. Therefore, in this embodiment, adjusting the altitude of the first shell body 1 makes the light-path distance A increase. Since the total light-path length TT is unchanged, it is possible to contract the other light-path length B, C, and D, and even to reduce the number of reflective mirrors, and to reach the function of reducing the volume of light-path apparatus 6.

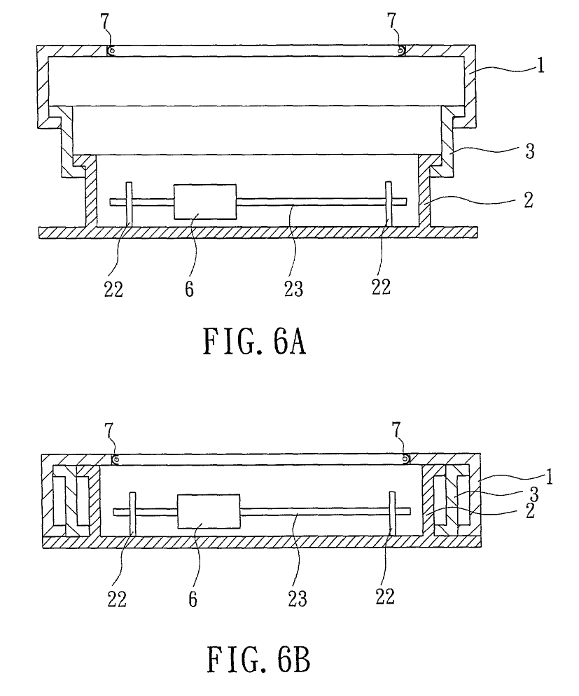

The members of the review committee please refer to the FIG. 6(A) and FIG. 6(B), which shows the illustration of the fifth preferred embodiment of this invention. During operation, adjusting the first shell body 1 to a stretching out position makes a larger containing space formed in the interior, and because the volume of the light-path apparatus 6 is reduced and the distance of the manuscript weight-bearing glass 10 is longer, the strength of original light source is insufficient for the scanning application. In this embodiment, changing the position of light-source apparatus 7 of the prior light-path apparatus 7 to be under the manuscript weight-bearing glass 10, and positioning the two light-source apparatus 7 on two sides of manuscript weight-bearing glass 10, and changing the manuscript weight-bearing glass 10 to a scattering glass, will distribute the light, provided by the light-source apparatus 7 on two sides, uniformly on the manuscript weight-bearing glass 10, and supply the sufficient light source for scanning.

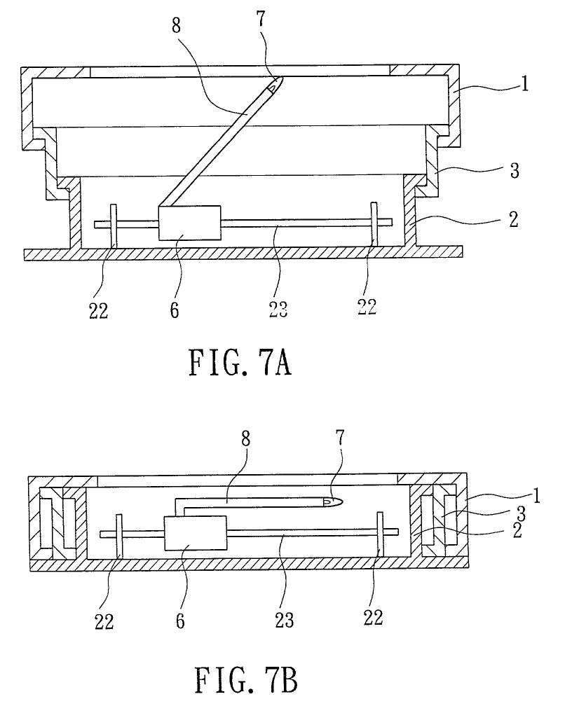

The members of the review committee please refer to the FIG. 7(A) and FIG. 7(B), which shows the illustration of the sixth preferred embodiment of this invention. In this embodiment, the guiding rod 23 is fixed on the second shell body 2 by a support 22. The light-path apparatus 6 moves back and forth along the guiding rod 23 for the process of scanning. The light-source apparatus 7 is arranged at one end of a stretch-contraction rod 8 near the manuscript weight-bearing glass 10, and the another end is connected to light-path apparatus 6 and is operated as an axis. In the contraction position for both upper and lower shell bodies, the stretch-contraction rod 8 will be pressed by the first shell body 1 and laid on light-path apparatus 6. In the stretching out position for both upper and lower shell bodies, the stretch-contraction rod 8 will stand up by nature. Further, the guiding rod 23 can also be fixed directly on middle lid 3 or on the first shell body 1 without the application of support 22, but under this condition, the light-path apparatus of the interior is changed, so the additional adjustment of the lens position is necessary.

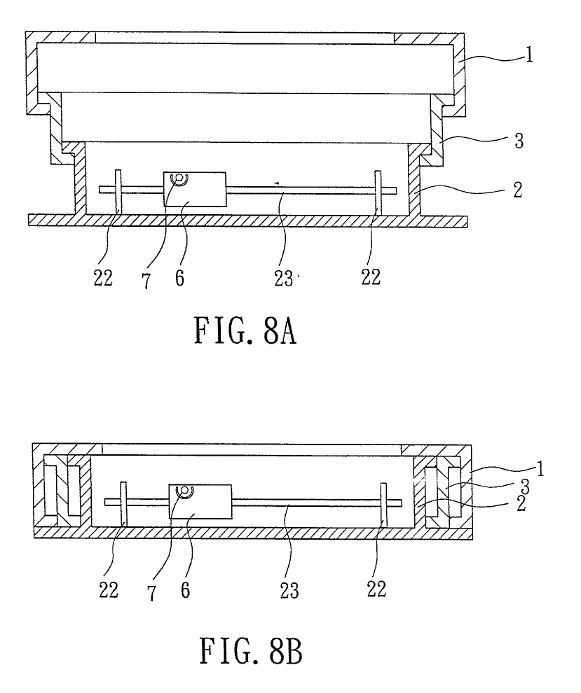

The members of the review committee please refer to the FIG. 8(A) and FIG. 8(B), which shows the illustration of the seventh preferred embodiment of this invention. In this embodiment, the light-source apparatus is arranged inside the light-path apparatus 6, but by the light-focusing function of light-source apparatus 6 will supply the sufficient light source for the process of scanning. In this embodiment, it is also very convenient for the putting-away and placing function in the idle situation as shown in FIG. 8(B). Without additional element, it is possible to reduce the whole volume during idle state. It is convenient for the effect of putting-away and placing with an extremely high practical-use.

However, the above said examples are only the preferred embodiments of the present invention and can not be as the restriction for the cope of this invention. For example, the fore-mentioned embodiments are as examples of scanner, but they can also be copy machine, printer or other scanning devices. According to the scope of the present invention, all the corresponding variation and decoration, are still not outside the main themes (essentials) of this invention, and are also within the spirit and scope of this invention, and are looked as the further implementation cases of this invention.

What is claimed is:

1. The contractible outer-shell apparatus of a scanning device, comprising:
a plurality of shell bodies, of which the interiors form a common containing space;
a light-path apparatus, which is accommodated in the containing space of the interior of the shell bodies, and which can process the scanning operation for the scanning zone;
a driving apparatus, which is arranged inside the shell bodies and connected with the light-path apparatus, and which can drive the light-path apparatus to process the linear motion;
the characteristics of the contractible outer-shell apparatus of the above-said scanning device are comprised of: at least a first shell body, in which there is a first space, and of which four side-surface constitute a trough opening, and in which one side is arranged with a manuscript weight-bearing glass; at least a second shell body, in which there is a second space, which can move along the direction confined by the trough opening of the first shell body between a contraction position and a stretch position to change the size of the containing space.

2. The contractible outer-shell apparatus of a scanning device according to claim 1, wherein a respectively matching buttoning-together mechanism is arranged on the connection location of the first shell body and the second shell body.

3. The contractible outer-shell apparatus of a scanning device according to claim 2, wherein there are four upper buttoning-together apparatus on the four side-surface of the first shell body and there are two sets totaling eight lower buttoning-together apparatus on the four side-surface of the second shell body.

4. The contractible outer-shell apparatus of a scanning device according to claim 1, wherein comprising an another middle lid arranged between the first shell body and the second shell body, the interiors of three bodies constitute a containing space after being connected.

5. The contractible outer-shell apparatus of a scanning device according to claim 1, wherein comprising another two sets of connection rods arranged on four side-surfaced of the first shell body and the second shell body, adjusting the connection rods will make the first shell body far away or near to the second shell body.

6. The contractible outer-shell apparatus of a scanning device according to claim 1, wherein four solenoid valves are arranged in the four corners of the second shell body respectively. By the rising and lowering motion of the solenoid valves will make the first shell body far away or near to the second shell body.

7. The contractible outer-shell apparatus of a scanning device according to claim 1, wherein the light-source apparatus is directly arranged under the manuscript weight-bearing glass of the first shell body.

8. The contractible outer-shell apparatus of a scanning device according to claim 1, wherein another light-path apparatus is arranged inside the containing space. A light-source apparatus is arranged at one end of a stretch-contraction rod near the manuscript weight-bearing glass. The another end of the stretch-contraction rod, connected with the light-source apparatus, is applied as an axis. In the contraction position for both upper and lower shell bodies, the stretch-contraction rod will be pressed by the first shell body 1 and laid on light-path apparatus naturally. In the stretching out position for both upper and lower shell bodies, the stretch-contraction rod 8 will stand up by nature and cast the image of light on to the light-path apparatus.

9. The contractible outer-shell apparatus of a scanning device according to claim 1, wherein another light-source apparatus is arranged inside the containing space. A light-source apparatus, with a strong effect of light focusing, is arranged inside the light-path apparatus.

10. The contractible outer-shell apparatus of a scanning device according to claim 1, wherein a light-path apparatus can be fixed on any shell body.
